(19) United States
(12) Patent Application Publication
(10) Pub. No.: US 2016/0091447 A1
(43) Pub. Date: Mar. 31, 2016

(54) GAS SENSOR APPARATUS

(71) Applicant: ELECTRONICS AND TELECOMMUNICATIONS RESEARCH INSTITUTE, Daejeon (KR)

(72) Inventors: Young Jun YU, Daejeon (KR); Jin Sik CHOI, Daejeon (KR); Choon Gi CHOI, Daejeon (KR); Hong Kyw CHOI, Busan (KR); Jin Soo KIM, Seoul (KR); Jin Tae Kim, Daejeon (KR); Kwang Hyo CHUNG, Daejeon (KR); Jong Ho CHOE, Seoul (KR)

(21) Appl. No.: 14/711,520

(22) Filed: May 13, 2015

(30) Foreign Application Priority Data
Sep. 26, 2014 (KR) 10-2014-0129500
Apr. 17, 2015 (KR) 10-2015-0054601

(51) Int. Cl. G01N 27/12

(52) U.S. Cl. CPC G01N 27/125

(57) ABSTRACT

Provided herein is a gas sensor apparatus including a first sensor unit, second sensor unit, and signal processing unit. The first sensor unit has a channel area doped to an n-type such that it may selectively react to a donor molecule in gas. The second sensor unit has a channel area doped to a p-type such that it may selectively react to an acceptor molecule in gas. The signal processing unit receives a sense signal of the donor molecule from the first sensor unit and a sense signal of the acceptor molecule from the second sensor unit, processes the received sense signals and generates result data of processing the received sense signals. Therefore, the gas sensor apparatus may selectively sense donor gas and acceptor gas.

### CROSS-REFERENCE TO RELATED APPLICATIONS

The present application claims priority to Korean Patent Application Numbers 10-2014-0129500 filed on Sep. 26, 2014 and 10-2015-0054601 filed on Apr. 17, 2015, in the Korean Intellectual Property Office, the entire disclosure of which is incorporated by reference herein.

### BACKGROUND

1. Field of Invention

Various embodiments of the present disclosure relate to a sensor apparatus, and more particularly, to a gas sensor apparatus configured to sense gas molecules.

2. Description of Related Art

Graphene which is a perfect sp2 combination has been widely explored for fabrication of gas sensors because of its conductivity that is easily changed by adhesion with external molecules. A conventional gas sensor using a graphene with no initial doping has same effects on atoms of molecules that serve as donors and acceptors existing outside in an equivalent proportion, and thus it is not possible to measure the molecules separately. Therefore, a gas sensor apparatus that can selectively sense different types of molecules is needed.

### SUMMARY

A purpose of the present disclosure is to provide a gas sensor apparatus wherein an initial doping is adjusted to an n-type or p-type so that it may sense molecules that serve as donors and acceptors separately.

An embodiment of the present disclosure provides a gas sensor apparatus including a first sensor unit with a channel area doped to an n-type such that it may selectively react to a donor molecule in gas; a second sensor unit with a channel area doped to a p-type such that it may selectively react to an acceptor molecule in gas; and a signal processing unit configured to receive a sense signal of the donor molecule from the first sensor unit and a sense signal of the acceptor molecule from the second sensor unit, process the received sense signals, and generate result data of processing the received sense signals.

In the embodiment, the apparatus may further include an output unit configured to receive the result data of processing the received sense signals from the signal processing unit, and output the same.

In the embodiment, the first sensor unit may include a first graphene layer formed on a substrate and configured to form the channel area; a first electrode layer formed on one side of the first graphene layer on the substrate; and a second electrode layer formed on another side of the first graphene layer on the substrate, and the first electrode layer and second electrode layer may include a material having a smaller work function than an initial work function of graphene, and by the material having a smaller work function than the initial work function of graphene, the first graphene layer may be doped to the n-type.

In the embodiment, the second sensor unit may include a second graphene layer formed on the substrate and configured to form the channel area; a third electrode layer formed on one side of the second graphene layer on the substrate; and a fourth electrode layer formed on another side of the second graphene layer on the substrate, and the third electrode layer and fourth electrode layer may include a material having a greater work function than the initial work function of graphene, and by the material having a greater work function than the initial work function of graphene, the second graphene layer may be doped to the p-type.

In the embodiment, the first electrode layer and second electrode layer may include at least one material of Ti (Titanium) and Al (Aluminum).

In the embodiment, the third electrode layer and fourth electrode layer may include at least one material of Au (Gold), Fe (Iron) and Cu (Copper).

In the embodiment, the first sensor unit may include a first graphene layer formed on the substrate and configured to form the channel area; a first electrode layer formed on one side of the first graphene layer on the substrate; and a second electrode layer formed on another side of the first graphene layer on the substrate, and in the first graphene layer, first particles made of a material having a smaller work function than an initial work function of graphene are injected, and by the first particles, the first graphene layer is doped to the n-type.

In the embodiment, the second sensor unit may include a second graphene layer formed on the substrate and configured to form the channel area; a third electrode layer formed on one side of the second graphene layer on the substrate; and a fourth electrode layer formed on another side of the second graphene layer on the substrate, and in the second graphene layer, second particles made of a material having a greater work function than an initial work function of graphene are injected, and by the second particles, the second graphene layer is doped to the p-type.

In the embodiment, the first electrode layer, second electrode layer, third electrode layer and fourth electrode layer may be made of a material having the same work function as graphene.

In the embodiment, the first electrode layer, second electrode layer, third electrode layer and fourth electrode layer may include W (Tungsten).

According to the present disclosure, a gas sensor capable of selectively sensing donor molecules and acceptor molecules is provided. That is, a gas sensor apparatus according to an embodiment of the present disclosure may perform sensing differently for when there are only donor molecules in gas, when there are only acceptor molecules in gas, and when there are both donor molecules and acceptor molecules in gas. Based on the above, it is possible to develop a selective gas molecule sensor system.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a block diagram illustrating a gas sensor apparatus according to an embodiment of the present disclosure;

FIG. 2 is a perspective view illustrating a concept of a first sensor unit and second sensor unit of the gas sensor apparatus according to an embodiment of the present disclosure;

FIG. 3 is a perspective view of illustrating a concept of a first sensor unit and second sensor unit of a gas sensor apparatus according to another embodiment of the present disclosure;

FIG. 4 is a perspective view illustrating a concept of a first sensor unit and second sensor unit of a gas sensor apparatus according to another embodiment of the present disclosure; and

FIG. 5 is a graph illustrating test results on polarization of different types of molecules according to the doped state of graphene.

### DETAILED DESCRIPTION

Hereinafter, embodiments will be described in greater detail with reference to the accompanying drawings. Embodiments are described herein with reference to cross-sectional illustrations that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present disclosure. Furthermore, ‘and/or’ may include any one of or a combination of the components mentioned.

Furthermore, a singular form may include a plural from as long as it is not specifically mentioned in a sentence. Furthermore, “include/comprise” or “including/comprising” used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

It is also noted that in this specification, “connected/coupled” refers to one component not only directly coupling another component but also indirectly coupling another component through an intermediate component. On the other hand, “directly connected/directly coupled” refers to one component directly coupling another component without an intermediate component.

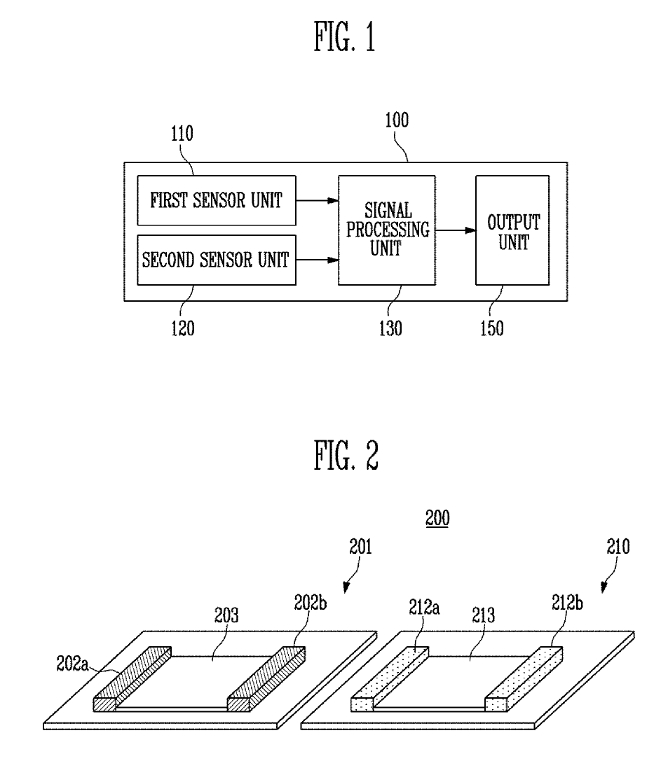

FIG. 1 is a block diagram illustrating a gas sensor apparatus according to an embodiment of the present disclosure.

Referring to FIG. 1, the gas sensor apparatus according to the embodiment of the present disclosure includes a first sensor unit 110, second sensor unit 120, signal processing unit 130 and output unit 150.

A channel area of the first sensor unit is doped to an n-type such that the channel area may selectively react to a donor molecule in gas (not illustrated). A channel area of the second sensor unit 120 is doped to a p-type such that the channel area may selectively react to an acceptor molecule in gas (not illustrated).

The signal processing unit 130 receives a sense signal of the donor molecule from the first sensor unit 110 and a sense signal of the acceptor molecule from the second sensor unit 120; processes the received sense signals; and generates result data of processing the received sense signals. That is, the signal processing unit 130 generates the result data of processing the received sense signals differently according to sense signals generated in the first sensor unit 110 and sense signals generated in the second sensor unit 120. For example, the signal processing unit 130 may generate the result data of processing the received sense signals differently for when the first sensor unit 110 generates a sense signal but the second sensor unit 120 does not generate a sense signal; when the first sensor unit 110 does not generate a sense signal but the second sensor unit 120 generates a sense signal; when the first sensor unit 110 and second sensor unit 120 both sense a sense signal; and when neither the first sensor unit 110 nor second sensor unit 120 generate a sense signal. Therefore, the result data of processing the received sense signals shows whether there exists a molecule serving as a donor, a molecule serving as an acceptor, both molecules serving as a donor and an acceptor, or neither molecule exist.

The output unit 150 receives the result data of processing the received sense signals and outputs the same. The output unit 150 may be a display apparatus configured to analyze the result data of processing the received sense signals and to output whether or not there exists a molecule serving as a donor and a molecule serving as an acceptor on a screen separately. In another embodiment, the output unit 150 may be an interface apparatus configured to transmit the result data of processing the received sense signal outside the gas sensor apparatus according to the embodiment of the present disclosure 100. In the case where the output unit 150 is the interface apparatus, the output unit 150 may provide the result data of processing the received sense signal such that the result data of whether or not there exists a molecule serving as a donor and a molecule serving as an acceptor in gas can be utilized by another apparatus.

A gas sensor that includes graphene in a channel area may sense whether or not there exists a molecule by measuring changes in conductivity caused by binding with the molecule. However, when the molecules to be measured include both molecules serving as donors and molecules serving as acceptors, the direction of changes in the conductivity of graphene with no initial doping will be mixed due to the two types of molecules, and thus it will not be possible to distinguish between them. The gas sensor apparatus according to the embodiment of the present disclosure 100 includes the first sensor unit 110 and second sensor unit 120 each having different initial doping conditions of n-type and p-type, and thus the first sensor unit 110 and second sensor unit 120 each senses different types of molecules. Therefore, the gas sensor apparatus according to the embodiment of the present disclosure 100 is capable of sensing molecules serving as donors and molecules serving as acceptors separately.

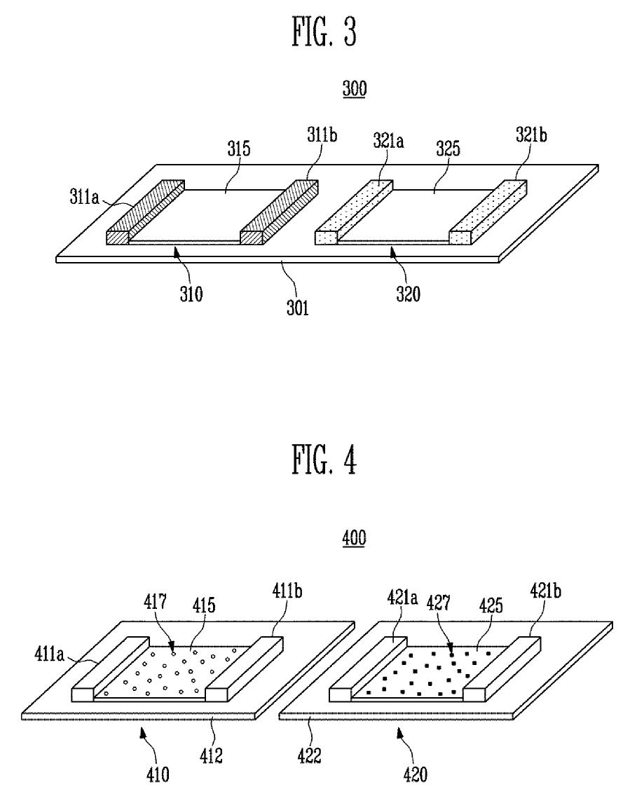

FIG. 2 is a perspective view illustrating a concept of a first sensor unit and second sensor unit of a gas sensor apparatus according to an embodiment of the present disclosure.

In FIG. 2, a gas sensor apparatus according to an embodiment of the present disclosure 200 is illustrated. The gas sensor apparatus 200 includes a first sensor unit 201 and second sensor unit 210. In FIG. 2, a structure of the first sensor unit 201 and second sensor unit 210 are illustrated, but the signal processing unit and output unit illustrated in FIG. 1 are omitted.

The first sensor 201 includes a first substrate 205, a first graphene layer 203 formed on the first substrate 205, a first electrode layer 202a formed on one side of the first graphene layer 203 on the first substrate 205, and a second electrode layer 202b formed on another side of the first graphene layer 203 on the first substrate 205.

The first substrate 205 may be made of a dielectric material, and thus the first substrate 205 may be a dielectric bottom layer. The first graphene layer 203 may for a channel area of the first sensor unit 201. The first and second electrode layer 202a, 202b may include a material having a smaller work function than an initial work function of the first graphene layer 203. Since the reported work functions of graphene is between about 4.4 and 4.5 (eV), the first and second electrode layer 202a, 202b may include materials having work functions that are lower than 4.4 (eV). For example, since the work function of Ti (Titanium) is 4.3 (eV), the first and second electrode layer 202a, 202b of the first sensor unit 201 that the gas sensor apparatus of the embodiment of the present disclosure 200 includes may be made of Ti. Meanwhile, since the work function of Al (aluminum) is between 4.06 and 4.26 (eV), the first and second electrode layer 202a, 202b may include Al. Materials that form the first and second electrode layer 202a, 202b are not limited to Ti and Al, and thus any material having a lower work function than graphene may be included in the first and second electrode layer 202a, 202b.

The second sensor unit 210 includes a second substrate 215, a second graphene layer 213 formed on the second substrate 215, a third electrode layer 212a formed on one side of the second graphene layer 213 on the second substrate 215, and a fourth electrode layer 212b formed on another side of the second graphene layer 213 on the second substrate 215.

The second substrate 215 may be made of a dielectric material, and thus it may be a dielectric bottom layer. The second graphene layer 213 may form a channel area of the second sensor unit 210. The third and fourth electrode layer 212a, 212b may include a material having a greater work function than the initial work function of the second graphene layer 213. Therefore, the third and fourth electrode layer 212a, 212b may include materials having greater work functions than 4.5 (eV). For example, since the work function of Au (Gold) is between 5.1 and 5.47 (eV), the third and fourth electrode layer 212a, 212b of the second sensor unit 210 that the gas sensor apparatus according to the embodiment of present disclosure 200 includes may be made of Au. Meanwhile, since the work function of Fe (Iron) is between 4.67 and 4.81 (eV), and the work function of Cu (Copper) is between 4.53 and 5.10 (eV), the third and fourth electrode layer 212a, 212b may include Fe or Cu. However, these are mere embodiments, and thus the materials that form the third and fourth electrode layers 212a, 212b are not limited to Au, Fe, and Cu. Any material that has a work function greater than graphene may be included in the third and fourth electrode layer 212a, 212b.

The first and second electrode layer 202a, 202b and the third and fourth electrode layer 212a, 212b change a doping state of the first graphene layer 203 and second graphene layer 213 differently from each other according to a size of work function relative to the graphene. That is, since the first and second electrode layer 202a 202b bound at one side of the first graphene layer 203 include materials having a smaller work function (less than 4.4 eV) than the graphene, an initial doping of the first graphene layer 203 becomes an n-type. On the contrary, since the third and fourth electrode layer 212a, 212b bound at one side of the second graphene layer 213 include materials having a work function greater than graphene (more than 4.5 eV), an initial doping of the second graphene layer 213 becomes a p-type.

Since the doping conditions of the first graphene layer 203 and second graphene layer 213 that form the channel area of the first sensor unit 201 and the channel area of the second sensor unit 210, respectively, are different from each other, the first sensor unit 201 and second sensor unit 210 perform an operation of sensing molecules in gas differently from each other. The first graphene layer 203 doped to an n-type reacts to molecules serving as a donor and thus its electric characteristics, that is the conductivity changes. Therefore, the first sensor unit 201 may sense whether or not there is a donor molecule in gas. On the contrary, the second graphene layer 213 doped to a p-type reacts to molecules serving as acceptors, and thus the electric characteristics, that is the conductivity changes. Therefore, the second sensor unit 210 may sense whether or not there is an acceptor molecule in gas.

It was explained that in the embodiment illustrated in FIG. 2, the first graphene layer 203 that forms the channel area of the first sensor unit 205 is doped to an n-type, and the second graphene layer 213 that forms the channel area of the second sensor unit 215 is doped to a p-type. However, the gas sensor apparatus according to the embodiment of the present disclosure is not limited thereto, and thus the graphene layer included in the first sensor unit may be doped to a p-type, and the graphene layer included in the second sensor unit may be doped to an n-type instead. In this case, the first sensor unit senses acceptor molecules, while the second sensor unit senses donor molecules.

As aforementioned, the gas sensor apparatus according to the embodiment of the present disclosure 200 includes the first and second sensor unit 201, 210, and the first and second graphene layer 203, 213 that form the channel area of the first and second sensor unit 201, 210, respectivelym are each doped to an n-type and p-type, respectively, and thus the gas sensor apparatus 200 may selectively sense the donors and acceptors in gas. As such, even when different types of molecules of different concentrations are exposed at the same time, the gas sensor apparatus 200 may selectively sense different types of molecules as the first sensor unit 201 and second sensor unit 210 identify and separate signals measured for specific molecules.

FIG. 3 is a perspective view illustrating a concept of a first sensor unit and second sensor unit of a gas sensor apparatus according to another embodiment of the present disclosure.

Referring to FIG. 3, the gas sensor apparatus according to another embodiment of the present disclosure includes a first sensor unit 310 and second sensor unit 320. The first sensor unit 310 includes a first graphene layer 315 formed on a substrate 201, a first electrode layer 311 a formed on one side of the first graphene layer 315 on the substrate 301, and a second electrode layer 311b formed on another side of the first graphene layer 315 on the substrate 301. The second sensor unit 320 includes a second graphene layer 325 formed on the substrate 301, a third electrode layer 321a formed on one side of the second graphene layer 325 on the substrate 301, and a fourth electrode layer 321b formed on another side of the second graphene layer 325 on the substrate 301. The difference between the gas sensor apparatus 300 of FIG. 3 and the gas sensor apparatus 200 of FIG. 2 is that in the gas sensor apparatus 300 of FIG. 3, the first and second sensor unit 310, 320 are formed on a single substrate 301. It is illustrated in FIG. 2 that the first and second sensor unit are formed on different substrates and are thus distanced from each other physically. In the gas sensor apparatus according to the embodiment of the present disclosure 300, the relative positions of the first sensor unit and second sensor unit are not limited to a certain embodiment. As illustrated in FIG. 3, the first sensor unit and second sensor unit may be formed relatively close to each other.

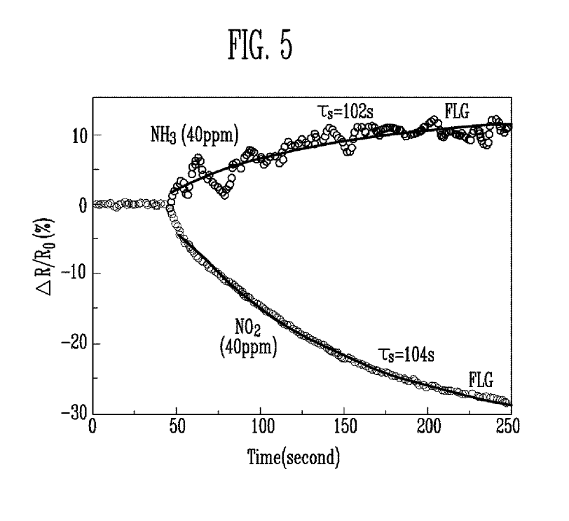

FIG. 4 is a perspective view illustrating a concept of a first sensor unit and second sensor unit of a gas sensor apparatus according to another embodiment of the present disclosure.

Referring to FIG. 4, the gas sensor apparatus according to another embodiment of the present disclosure 400 includes a first sensor unit 410 and second sensor unit 420. Just as in FIG. 2, the signal processing unit and output unit illustrated in FIG. 1 are omitted in FIG. 4 as well.

The first sensor unit 410 includes a first substrate 412, a first graphene layer 415 formed on the first substrate 412, a first electrode layer 411 a formed on one side of the first graphene layer 415 on the first substrate 412, and a second electrode layer 411b formed on another side of the first graphene layer 415 on the first substrate 412.

The first substrate 412 may be made of a dielectric material, and thus the first substrate 412 may be a dielectric bottom layer. The first graphene layer 415 may form a channel area of the first sensor unit 410. On the first graphene layer 415, a plurality of first particles 417 are injected. The first particles 417 may be made of materials having a smaller work function than the initial work function of graphene. By the first particles 417 injected into the first graphene layer 415, the first graphene layer 415 may be doped to an n-type. Since the reported work function of graphene is between about 4.4 and 4.5 (eV), the first particles 417 injected into the first graphene layer 415 may include materials having a work function that is smaller than 4.4 (eV). For example, since the work function of Ti (Titanium) is 4.3 (eV), the first particles 417 being injected into the first graphene layer 415 of the first sensor unit 410 that the gas sensor apparatus according to the embodiment of the present disclosure 400 includes may include Ti. Meanwhile, since the work function of Al (Aluminum) is between 4.06 and 4.26 (eV), the first particles 417 may include Al. The materials that form the first particles 417 are not limited to Ti and Al, and thus any material having a work function smaller than graphene may be included in the first particles 417.

Meanwhile, the first and second electrode layer 411a, 411b that are bound to the first graphene layer 417 may include materials that do not affect the work function of graphene. For example, since the work function of W (Tungsten) is about 4.5 (eV), it is substantially the same as the work function of graphene. Therefore, the first and second electrode layer 411a, 411b may include W. The materials that form the first and second electrode layer 411a, 411b according to the embodiment of the present disclosure are not limited to W, and thus any material having substantially the same work function as graphene may be included in the first and second electrode layer 411a, 411b.

The second sensor unit 420 includes a second substrate 422, a second graphene layer 425 formed on the second substrate 422, a third electrode layer 421 a formed on one side of the second graphene layer 425 on the second substrate 422, and a fourth electrode layer 421b formed on another side of the second graphene layer 425 on the second substrate 422.

The second substrate 422 may be made of a dielectric material, and thus the second substrate 422 may be a dielectric bottom layer. The second graphene layer 425 may form a channel area of the second sensor unit 420. In the second graphene layer 425, a plurality of second particles 427 are injected. The second particles 427 may be made of materials having a greater work function than the initial work function of graphene. By the second particles 427 injected into the second graphene layer 425, the second graphene layer 425 may be doped to a p-type. Therefore, the second particles 427 injected into the second graphene layer 425 may include materials having a greater work function than 4.5 (eV).

For example, since the work function of Au (Gold) is between 5.1 and 5.47 (eV), the second particles 427 being injected into the second graphene layer 425 of the second sensor unit 420 that the gas sensor apparatus according to the embodiment of the present disclosure 400 includes may include Au. Meanwhile, since the work function of Fe (Iron) is between 4.67 and 4.81 (eV) and the work function of Cu (Copper) is between 4.53 and 5.10 (eV), the second particles 427 may include Fe or Cu. However, this is a mere embodiment, and thus the materials that form the second particles 427 are not limited to Au, Fe, and Cu. Any material having a work function greater than graphene may be included.

Meanwhile, the third and fourth electrode layer 421a, 421b that are bound to the second graphene layer 427 may include materials that do not affect the work function of graphene. For example, the third and fourth electrode layer 421a, 421b may include W (Tungsten). The materials that form the third and fourth electrode layer 421a, 421b according to the embodiment of the present disclosure are not limited to W, and thus any material having substantially the same function as graphene may be included.

The first particles 417 and second particles 427 change a doping state of the first graphene layer 415 and second graphene layer 425 differently from each other according to a size of work function relative to graphene. That is, since the first particles 417 injected into the first graphene layer 415 include materials having a smaller work function (less than 4.4 eV) than graphene, the initial doping of the first graphene layer 415 becomes an n-type. On the contrary, since the second particles 427 injected into the second graphene layer 425 include materials having a greater work function (more than 4.5 eV) than graphene, the initial doping of the second graphene layer 425 becomes a p-type.

Since the doping conditions of the first graphene layer 415 and second graphene layer 425 that form the channel area of the first sensor unit 410 and the channel area of the second sensor unit 420 are different from each other, the first sensor unit 410 and second sensor unit 420 perform an operation of sensing molecules in gas differently from each other. The first graphene layer 415 doped to an n-type reacts to molecules serving as donors and thus its electric characteristics, that is the conductivity changes. Therefore, the first sensor unit 415 may sense whether or not there is a donor molecule in gas. On the contrary, the second graphene layer 425 doped to a p-type reacts to molecules serving as acceptors, and thus the electric characteristics, that is the conductivity changes. Therefore, the second sensor unit 425 may sense whether or not there is an acceptor molecule in gas.

It was explained that in the embodiment illustrated in FIG. 4, the first graphene layer 415 that forms the channel area of the first sensor unit 410 is doped to an n-type, and the second graphene layer 425 that forms the channel area of the second sensor unit 420 is doped to a p-type. However, the gas sensor apparatus according to the embodiment of the present disclosure is not limited thereto, and thus the graphene layer included in the first sensor unit may be doped to a p-type, and the graphene layer included in the second sensor unit may be doped to an n-type instead. In this case, the first sensor unit senses acceptor molecules, while the second sensor unit senses donor molecules.

As aforementioned, the gas sensor apparatus according to the embodiment of the present disclosure 400 includes the first and second sensor unit 410, 420, and the first and second graphene layer 415, 425 that form the channel area of the first and second sensor unit 410, 420, respectively, are each doped to an n-type and p-type, respectively, and thus the gas sensor apparatus 400 may selectively sense the donors and acceptors in gas. As such, even when different types of molecules of different concentrations are exposed at the same time, the gas sensor apparatus 400 may selectively sense different types of molecules as the first sensor unit 410 and second sensor unit 420 identify and separate signals measured for specific molecules.

According to the explanation on the embodiments illustrated in FIGS. 2 to 4 and related explanation on the present disclosure, the initial doping conditions of graphene are adjusted by either having the electrode bound to the graphene layer include a material having a work function different from graphene, or by injecting particles having a work function different from graphene directly into the graphene layer. However, there is no limitation to the initial doping method of graphene that forms a channel area in the gas sensor apparatus according to the embodiment of the present disclosure, and thus any gas sensor apparatus that includes two or more sensor units having different doping conditions such that it may selectively sense donor molecules and acceptor molecules separately is within the scope of the gas sensor apparatus according to the present disclosure.

FIG. 5 is a graph illustrating test results on polarization of different types of molecules according to a doped state of graphene.

FIG. 5 illustrates a graph for resistance change rates (ΔR/R0) as a function of time. Furthermore, FIG. 5 illustrates a resistance change rate (ΔR/R0) of when a graphene channel layer is exposed to 40 ppm of NH₃ gas molecules, and a resistance change rate (ΔR/R0) of when the graphene channel layer is exposed to 40 ppm of NO₂ gas molecules. The resistance change rates (ΔR/R0) start to change from 50 seconds, and the tendency line that goes upwards as it goes to the right near the 50 seconds represents the resistance change rate (ΔR/R0) of when the graphene channel layer was exposed to NH₃ gas molecules. Furthermore, the tendency line that goes downwards as it goes to the right near the 50 seconds represents the resistance change rate (ΔR/R0) of when the graphene channel layer was exposed to NO₂ gas molecules.

As illustrated in FIG. 5, the resistance change rate (ΔR/R0) of the graphene channel when exposed to NO₂ gas is −28% during 104 seconds of time change(τ), and the resistance change rate (ΔR/R0) of the graphene channel when exposed to NH₃ gas is +13% during 102 seconds of time change(τ). As such, when the channel layer of graphene initially doped to a p-type is exposed to NO₂ gas molecules serving as acceptors, a greater signal change can be seen than when exposed to NH₃ gas serving as donors.

Based on the aforementioned, it can be expected that in the case of a sensor unit that includes a graphene channel doped to an n-type, a signal measured for molecules serving as donors will be greater than that of the molecules serving as acceptors. Therefore, it is possible to measure different types of molecules through the first sensor unit and second sensor unit that include graphene channels having different doping states. Therefore, since the gas sensor apparatus according to the embodiment of the present disclosure includes a first sensor unit that includes a graphene channel doped to an n-type, and a second sensor unit that includes a graphene channel doped to a p-type, it is capable of sensing gas serving as a donor and gas serving as an acceptor separately.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A gas sensor apparatus comprising:
a first sensor unit with a channel area doped to an n-type such that it may selectively react to a donor molecule in gas;
a second sensor unit with a channel area doped to a p-type such that it may selectively react to an acceptor molecule in gas; and
a signal processing unit configured to receive a sense signal of the donor molecule from the first sensor unit and a sense signal of the acceptor molecule from the second sensor unit, process the received sense signals, and generate result data of processing the received sense signals.

2. The apparatus according to claim 1,
further comprising an output unit configured to receive the result data of processing the received sense signals from the signal processing unit, and output the same.

3. The apparatus according to claim 1,
wherein the first sensor unit comprises:
a first graphene layer formed on a substrate and configured to form the channel area;
a first electrode layer formed on one side of the first graphene layer on the substrate; and
a second electrode layer formed on another side of the first graphene layer on the substrate, and
the first electrode layer and second electrode layer include a material having a smaller work function than an initial work function of graphene, and
by the material having a smaller work function than the initial work function of graphene, the first graphene layer is doped to the n-type.

4. The apparatus according to claim 3,
wherein the second sensor unit comprises:
a second graphene layer formed on the substrate and configured to form the channel area;
a third electrode layer formed on one side of the second graphene layer on the substrate; and
a fourth electrode layer formed on another side of the second graphene layer on the substrate, and
the third electrode layer and fourth electrode layer include a material having a greater work function than the initial work function of graphene, and
by the material having a greater work function than the initial work function of graphene, the second graphene layer is doped to the p-type.

5. The apparatus according to claim 3,
wherein the first electrode layer and second electrode layer include at least one material of Ti (Titanium) and Al (Aluminum).

6. The apparatus according to claim 4,
wherein the third electrode layer and fourth electrode layer include at least one material of Au (Gold), Fe (Iron) and Cu (Copper).

7. The apparatus according to claim 1,
wherein the first sensor unit comprises:
a first graphene layer formed on the substrate and configured to form the channel area;
a first electrode layer formed on one side of the first graphene layer on the substrate; and
a second electrode layer formed on another side of the first graphene layer on the substrate, and
in the first graphene layer, first particles made of a material having a smaller work function than an initial work function of graphene are injected, and by the first particles, the first graphene layer is doped to the n-type.

8. The apparatus according to claim 7,
wherein the second sensor unit comprises:
a second graphene layer formed on the substrate and configured to form the channel area;
a third electrode layer formed on one side of the second graphene layer on the substrate; and
a fourth electrode layer formed on another side of the second graphene layer on the substrate, and
in the second graphene layer, second particles made of a material having a greater work function than an initial work function of graphene are injected, and by the second particles, the second graphene layer is doped to the p-type.

9. The apparatus according to claim 8,
wherein the first electrode layer, second electrode layer, third electrode layer and fourth electrode layer are made of a material having the same work function as graphene.

10. The apparatus according to claim 9,
wherein the first electrode layer, second electrode layer, third electrode layer and fourth electrode layer include W (Tungsten).
